(19) United States
(12) Patent Application Publication
(10) Pub. No.: US 2025/0061439 A1
(43) Pub. Date: Feb. 20, 2025

(54) SYSTEMS AND METHODS FOR SHARED ACCOUNTS

(71) Applicant: Wells Fargo Bank, N.A., San Francisco, CA (US)

(72) Inventors: Ashish B. Kurani, Hillsborough, CA (US); Alan W. Hecht, Chanhassen, MN (US); Muhammad Farukh Munir, Pittsburg, CA (US); Darius A. Miranda, San Francisco, CA (US); Benjamin Taylor, Willston, VT (US); Traci Nguyen, San Francisco, CA (US); Kourtney Eidam, Marietta, GA (US); Wairnola Marria Rhodriguez, San Francisco, CA (US)

(73) Assignee: Wells Fargo Bank, N.A., San Francisco, CA (US)

(21) Appl. No.: 18/235,764

(22) Filed: Aug. 18, 2023

(51) Int. Cl. G06Q 20/22; G06Q 20/10; G06Q 20/42

(52) U.S. Cl. CPC G06Q 20/229; G06Q 20/102; G06Q 20/42

(57) ABSTRACT

Systems and methods for shared accounts may include a computing system which receives a request to form a shared account. The computing system may generate the shared account, transmit message(s) to second user device(s), generate link(s) between second accounts and the shared account, and establish a value associated with the shared account. The computing system may receive a selection to initiate a transfer, detect that the value satisfies a threshold criteria, identify an eligible member, and initiate a transfer based on a response from the eligible member.

### TECHNICAL FIELD

The present disclosure relates to account management including systems and methods for distributed accounts.

### BACKGROUND

Many methods for sharing expenses, transferring funds, and loaning money exist. Conventionally, a person wishing to procure a financial loan does so through formal channels like a credit union, which tends to have high costs associated, or through informal personal channels, which poses risk to the lender and are often one-off transactions. High costs and risk pose challenges and hesitancy toward lending in general.

### SUMMARY

This disclosure relates to systems, methods, and computer-readable media for generating shared accounts.

At least one aspect of the disclosure relates to a method. The method includes: receiving, by a computing system, a request from a first user device associated with a first member to form a shared account with one or more second members, the request including information identifying a first account of the first member; generating, by the computing system, the shared account including a first link between the shared account and the first account, wherein the generated shared account includes a unique account number indicating the shared account is accessible by multiple members; transmitting, by the computing system, one or more messages to one or more second user devices associated with the one or more second members; generating, by the computing system, one or more second links between one or more second accounts of the one or more second members and the shared account, the one or more second links generated according to a response to the one or more messages received from the one or more second user devices; establishing, by the computing system, a value associated with the shared account, the value having a first portion associated with the first account and one or more second portions associated with each of the one more second accounts; receiving, by the computing system, an input via the first user device indicating a selection to initiate an inbound transfer of a first amount from the first account to the shared account to increase the value associated with the shared account; detecting, by the computing system, that the value associated with the shared account satisfies a threshold criteria; identifying, by the computing system, an eligible member from among the first member and the second member responsive to the value satisfying the threshold criteria and according to at least one machine learning model that considers financial transaction information of each linked second member; transmitting, by the computing system, a notification to the user device of the eligible member, the notification indicating availability of an outbound transfer from the shared account to the account of the eligible member; receiving, by the computing system, a response from the user device, the response selecting to initiate the outbound transfer from the shared account to the account of the eligible member; initiating, by the computing system, the outbound transfer in an amount specified in the response from the shared account to the account of the eligible member.

At least one aspect of the disclosure relates to a computing system. The computing system includes a network interface; a first database structured to store a plurality of accounts of a provider; a second database structured to store a plurality of shared accounts containing group member information; and a processing circuit comprising one or more processors and a memory, the processing circuit configured to: receive, via the network interface, a request from a first user device associated with a first member to form a shared account with one or more second members, the request including information for identifying a first account of the first member; generate, in the second database, the shared account including a first link between the shared account of the second database and the first account of the first database, wherein the generated shared account includes a unique account number indicating the shared account is accessible by multiple members; transmit, via the network interface, one or more messages to one or more second user devices associated with the one or more second members; generate one or more second links between one or more second accounts of the one or more second members of the first database and the shared account of the second database, the one or more second links generated according to a response to the one or more messages received from the one or more second user devices; establish a value associated with the shared account, the value having a first portion associated with the first account and one or more second portions associated with the second account; receive, via the network interface, an input via the first user device indicating a selection to initiate an inbound transfer of a first amount from the first account to the shared account, to increase the value associated with the shared account; detect that the value associated with the shared account satisfies a threshold criteria; identify an eligible member from among the first member and the second member responsive to the value satisfying the threshold criteria and according to at least one machine learning model that considers financial transaction information of each linked second member; transmit, via the network interface, a notification to the user device of the eligible member, the notification indicating availability of an outbound transfer from the shared account to the account of the eligible member; receive, via the network interface, a response from the user device, the response selecting to initiate the outbound transfer from the shared account to the account of the eligible member; initiate the outbound transfer in an amount specified in the response from the shared account to the account of the eligible member.

In some embodiments, the computing system may initiate a second inbound transfer from the account of the eligible member in the amount to the shared account. In some embodiments, the outbound transfer includes a loan against the shared account, and where the second inbound transfer includes a repayment of the loan. In some embodiments, the computing system determines an access pattern of first user and the one or more second members. The eligible member may be identified according to the access pattern. In some embodiments, the access pattern is determined by analysis of transactions within an account of the first member and an account of the second member.

In some embodiments, the inbound transfer includes a recurring inbound transfer from the first account to the shared account. In some embodiments, the notification includes a withdrawal allowance notification, and a user interface element allowing for the eligible user to defer the withdrawal to another user within the shared financial account. In some embodiments, the notification includes a withdrawal allowance notification, and a user interface element for receiving a selection of the amount to transfer via the outbound transfer. In some embodiments, the first user is the eligible user responsive to the first portion associated with the first account exceeding a threshold value.

At least one aspect of the disclosure relates to a non-transitory computer readable medium storing instructions that, when executed by one or more processors of a processing system, cause the processing system to perform operations comprising: receiving, via a network interface, a request from a first user device associated with a first member, the request to form a shared account with one or more second members, the request including information for identifying a first account of the first member; generating, in a first database, the shared account including a first link between the shared account of the first database and the first account of a second database, wherein the generated shared account includes a unique account number indicating the shared account is accessible by multiple members; transmitting, via the network interface, one or more messages to one or more second user devices associated with the one or more second users; generating one or more second links between one or more second accounts of the one or more second users of the first database and the shared account of the second database, the one or more second links generated according to a response to the one or more messages received from the one or more second user devices; establishing a value associated with the shared account, the value having a first portion associated with the first account and one or more second portions associated with the second account; receiving, via the network interface, an input via the first user device indicating a selection to initiate an inbound transfer of a first amount from the first account to the shared account, to increase the value associated with the shared account; detecting that the value associated with the shared account satisfies a threshold criteria; identifying an eligible member from among the first member and the second member responsive to the value satisfying the threshold criteria and according to at least one machine learning model that considers financial transaction information of each linked second member; transmitting, via the network interface, a notification to the user device of the eligible member, the notification indicating availability of an outbound transfer from the shared account to the account of the eligible member; receiving, via the network interface, a response from the user device, the response selecting to initiate the outbound transfer from the shared account to the account of the eligible member; and initiating the outbound transfer in an amount specified in the response from the shared account to the account of the eligible member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing system for establishing and maintaining a shared account, according to an example embodiment.

FIG. 2 is a flow diagram of a method of generating a shared account, according to an example embodiment.

FIG. 3 is a block diagram displaying attributes of a shared account, according to an example embodiment.

FIG. 4 is a flow diagram of a method of initiating transfers between a shared account and an individual account for a withdrawal process, according to an example embodiment.

FIG. 5 depicts example graphical user interfaces involving notifications based on a shared account displayed on a customer device, according to example embodiments.

### DETAILED DESCRIPTION

Referring generally to the figures, systems, computer-readable media, and methods for managing a resource (e.g., lending an amount of money) in a fraud-reduced and more affordable manner are disclosed according to various embodiments described herein. In some instances, the systems, computer-readable media, and methods described herein allow for users to register with a service provided by a provider computing system by receiving financial account information associated with the users. A provider computing system associated with a provider institution (e.g., financial institution) may allow a user to initiate a resource transfer from a financial account owned by the user to a shared account. The provider computing system may allow a user to effectuate a resource transfer (e.g., payment) from a shared account to a financial account owned by the user. Beneficially, the provider computing system may examine all (or, in some embodiments, a select grouping of) user financial accounts linked with the shared account to determine which user may need access to the shared funds at any time. Furthermore, the systems, computer-readable media, and methods described herein generate and provide various user interfaces to a device of a user to allow fund transactions, observe fund transaction history, manage attributes of the shared account, and various other functionalities described herein.

By way of example, if a user has made several large transactions in a short timeframe from their personal financial account, the user may be in need of financial assistance to cover certain existing and/or upcoming expenses. Accordingly, receiving a loan at the time of need may be challenging for users due to upfront costs or planning. Beneficially, the systems, computer-readable media, and methods described herein provide various technical solutions to problems and shortcomings of conventional lending systems. For example, the systems, computer-readable media, and methods described herein operate in a non-conventional way by examining the financial accounts of lending group members, and may determine, from the transaction history of a financial account, predictively, or otherwise, a next user in need of withdrawing funds from the account.

In various embodiments, the systems, computer-readable media, and methods described herein may be related to generating and maintaining shared accounts. According to the systems, computer-readable media, and methods described herein, the shared account may be accessible by each of the members, whereby each person has the option to take the resources of the shared account, but is then obligated to replenish the shared account. For example, there may be ten people who each contribute $1000 per month. A first user may need $10,000 for a down-payment and, as such, requests the pool. The user obtains the pool, but then owes $9,000 going forward. This, the account is “shared” amongst the group.

According to the systems, computer-readable media, and methods described herein, a provider institution application associated with the provider institution is provided that includes a user interface that enables the addition of people (e.g., via email, phone number, username, etc.) to join and/or create a shared account. The application may access one's contacts and send invites to people along with an amount of suggested funds to contribute. An administrator or owner of the shared account may then define the attributes of the shared account: i) contribution amount and time (e.g., a monthly contribution of $1000), ii) order of use of the shared account (e.g., alphabetical, random, etc.), iii) terms and conditions for repayment (e.g., an interest amount on the repayment amount), iv) whether partial fund withdrawal is allowed (e.g., an amount less than the total balance), and so on. For each user, the application may then depict various features of the shared account: balance information, who drew from the fund most recently, etc. The shared account may be accessible in a virtual reality world so that individuals can engage with each other regarding the account.

Beneficially, one or more accounts of each individual may be linked to the shared account. The system may then perform analytics on the individually linked accounts in relation to the shared account. For example, the system may analyze transactions of the individual members to determine who may need the shared resources at a particular withdrawal period. The system may then determine an order of withdrawal based on the determined need. The order may be hidden to each individual user so as to mitigate linked users from trying to draw out-of-turn or otherwise manipulate the system. Rather, the user may receive a notification that it is their turn to withdraw, a deadline to make the withdrawal, and an option to pass on the withdrawal. These GUI features are provided by the application. Withdrawing and depositing may be automatic via a linking to the individuals' accounts. This may ease the burden of use.

Technically and beneficially, the systems and methods described herein provide various technical solutions to the various problems and shortcomings of conventional resource transfer systems as alluded to above. For example, the systems and methods described herein operate in a non-conventional way by coupling users for a shared objective to manage a pool of resources fairly and efficiently. Furthermore, the systems and methods described herein provide a unique way to group users in which users may be required to physically touch their respective devices together prior to joining the shared account. This is unconventional and facilitates reducing fraudulent activity (e.g., fraudsters cannot gain access to a code or other invitation to the shared account). Accordingly, the systems and methods described herein provide a non-conventional operation of allowing members to pool resources together in a safe, efficient manner. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

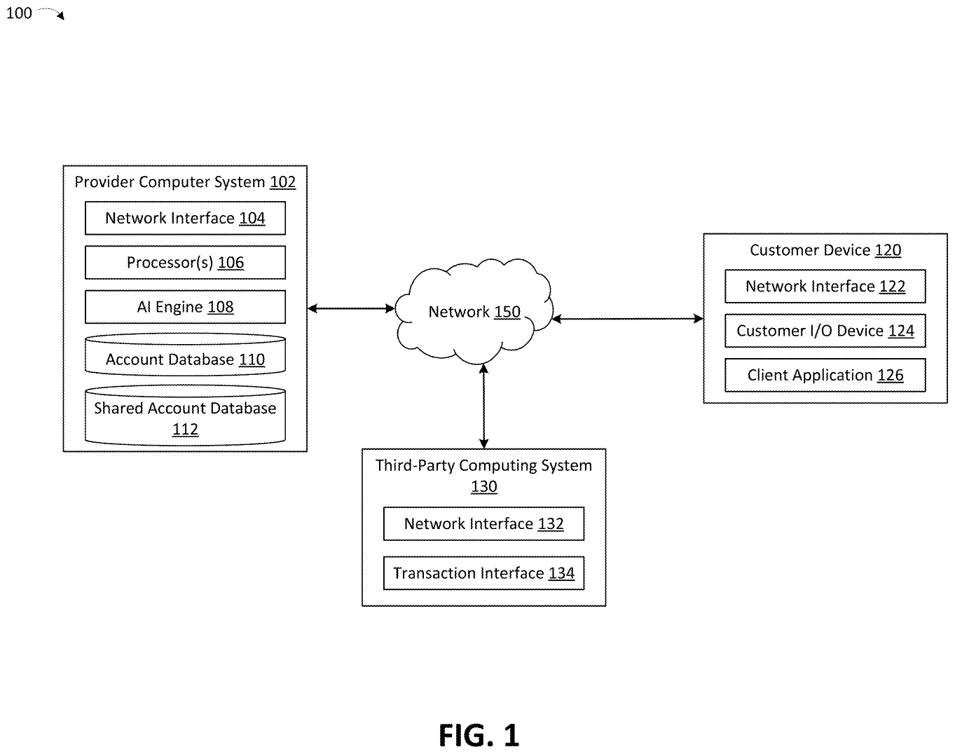

FIG. 1 is a diagram of a computing environment 100 for establishing and maintaining a shared account, according to an example embodiment. As shown, the computing environment 100 includes one or more provider computing systems 102 associated with a provider (e.g., a financial institution), one or more customer devices 120 associated to one or more users, one or more third-party computing systems 130, and a network 150 which may include one or more of the Internet, cellular network, Wi-Fi, Wi-Max, a proprietary banking network, or any other type of wired or wireless network or a combination of wired and wireless networks. As described herein, the computing environment 100 may be used to provider a user interface to the first customer device or the second customer device to allow for easy account management and resource management between/across various accounts of the user.

For clarity, the following description will refer to a provider computing system 102, one or more customer devices 120, and a third-party computing system 130. However, it will be understood that the following description of any of these devices and computing systems will be similarly applicable to any additional corresponding devices and computing systems (e.g., additional provider computing systems 102) and that, in some embodiments, the computing environment 100 may include a plurality of any of the described devices and systems.

The provider computing system 102 may be owned by, associated with, or otherwise operated by a provider institution (e.g., a bank, a credit union, or other financial institution) that maintains one or more accounts held by various customers (e.g., the customer associated with the customer device 120), such as demand deposit accounts, credit card accounts, receivables accounts and so on. As described in greater detail below, the provider computing system 102 may be configured to maintain one or more shared accounts held or maintained for a plurality of customers or users. Such a shared account may be accessible by each of the plurality of customers or users, such that the customers or users may be capable of transferring funds between (e.g., to and/or from) the shared account and an individual (e.g., non-shared, such as business or personal) account. The shared account may be shared across multiple customers or users.

In some embodiments, the provider computing system 102 may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some embodiments, the provider computing system 102 may be or may include various other devices communicably coupled thereto, such as, for example, desktop or laptop computers (e.g., tablet computers), smartphones, wearable devices (e.g., smartwatches), virtual reality devices (e.g., headsets), and/or other suitable devices.

In some embodiments, the provider computing system 102 includes an AI engine 108, an accounts database 110, a shared accounts database 112 and a network interface circuit 104. In some embodiments, the network interface circuit 104 includes, for example, program logic that connects the provider computing system 102 to the network 150. The network interface circuit 104 facilitates secure communications between the provider computing system 102, customer device(s) 120, and/or a third-party computing system 130. The network interface 104 also facilitates communication with other entities such as other banks, settlement systems, and so on. The network interface 104 further includes user interface logic configured to generate and present web pages and graphical user interfaces to users accessing the provider computing system 102 over the network 150.

The account database 110 is structured or configured to contain, store, include, or otherwise maintain information on financial accounts associated with the provider. Additionally, the account database 110 may contain transaction information, information pertaining to the type and corresponding capabilities of a given account. Similarly, the shared account database 112 is structured or configured to maintain a plurality of shared accounts and associated information (e.g., shared account members, linked financial accounts, customer device information, etc.). As described in greater detail below, the provider computing system 102 may be configured to generate, create, or otherwise establish new shared accounts (e.g., responsive to received requests from various user devices). As part of establishing shared accounts, the provider computing system 102 may be configured to generate various notifications to devices associated with shared members (e.g., members identified in the request with which the shared account is to be shared). The provider computing system 102 may be configured to establish various links between the financial accounts (e.g., between the shared account of the shared accounts database 112 and accounts of the accounts database 110) based on responses from the devices to the various notifications.

The customer device 120 is owned, operated, controlled, managed, and/or otherwise associated with a customer (e.g., a customer of the financial institution). In some embodiments, the customer device 120 may include, for example, a desktop or laptop computer (e.g., a tablet computer), a smartphone, a wearable device (e.g., a smartwatch), a personal digital assistance, a virtual reality device (e.g., virtual reality headset), and/or any other suitable computing device. In the example described herein, the customer device 120 is structured as a mobile computing device, namely a smartphone.

The network interface 122 includes, for example, program logic and various devices (e.g., transceivers, etc.) that connect the customer device 120 to the network 150. The network interface circuit 122 facilitates secure communications between customer device(s), third-party computing systems, and/or the provider computing system 102. The network interface circuit 122 also facilitates communication with other entities, such as other banks, settlement systems, and so on.

In some embodiments, the customer device 120 includes one or more I/O devices 124, and one or more customer client applications 126. While the term “I/O” is used, it should be understood that the I/O devices 124 may be input-only devices, output-only devices, and/or a combination of input and output devices. In some instances, the I/O devices 124 include various devices that provide perceptible outputs (such as display devices with display screen and/or light sources for visually perceptible elements, an audio speaker for audible elements, and haptics or vibration devices for perceptible signaling via touch, etc.), that capture ambient lights and sounds (such as digital cameras, microphones, etc.), and/or that allow the customer to provide inputs (such as a touchscreen display, stylus, keyboard, force sensor for sensing pressure on a display screen, acceleration sensor for tracking motion, etc.). In some instances, the I/O devices 124 further include one or more user interfaces (devices or components that interface with the customer), which may include one or more biometric sensors (such as a fingerprint reader, a heart monitor that detects cardiovascular signals, face scanner, an iris scanner, etc.).

The customer device 120 stores in computer memory and executes (“runs”) using one or more processors, various customer client applications 126, such as an Internet browser presenting websites, text messaging applications (e.g., for sending MMS or SMS to the provider computing system 102, another customer device 120, and/or the third-party computing system 130), and/or applications provided or authorized by entities implementing or administering any of the computing systems in computing environment 100.

In some embodiments, the client applications 126 may include a customer provider institution client application (e.g., a financial institution banking application) provided by and at least partly supported by the provider computing system 102. For example, in some instances, the client application 126 coupled to the provider computing system 102 may enable the customer to perform various customer activities (e.g., transferring money to another financial account, etc.) associated with one or more customer accounts of the customer held at the provider institution associated with the provider computing system 102 (e.g., account opening and closing operations, fund transfers, etc.).

With an example structure of the computing environment 100 being described above, example processes performable by the computing environment 100 (or components/systems thereof) will be described below. It should be appreciated that the following processes are provided as examples and are in no way meant to be limiting. Additionally various method steps discussed herein may be performed in a different order or, in some instances, completely omitted. These variations have been contemplated and are within the scope of the present disclosure.

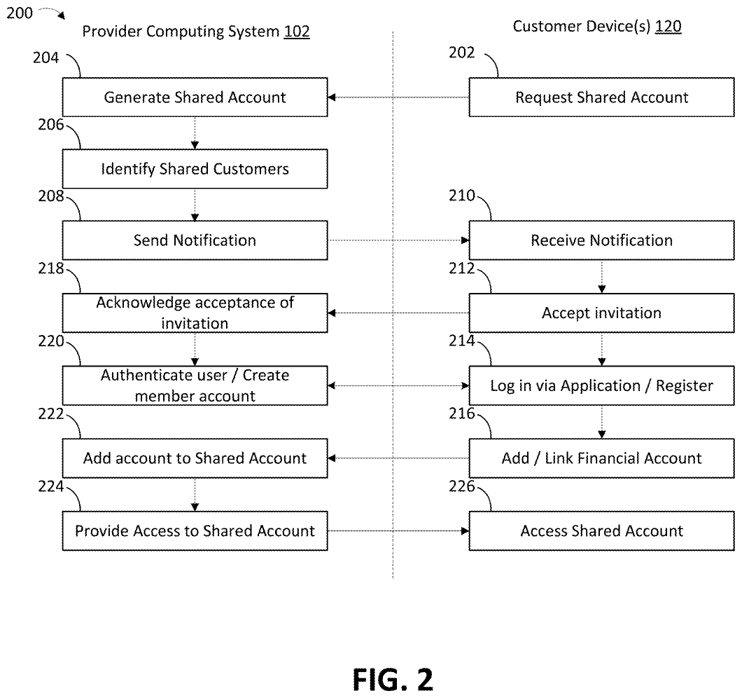

Referring now to FIG. 2, depicted is a flowchart showing an example method 200 of generating, operating, and managing a shared account, according to an example embodiment of the present disclosure. The method 200 may be performed by the components, elements, or hardware described above with reference to FIG. 1 (for example, the provider computing system 102 and various customer devices 120). In various embodiments, one customer device 120 may perform one or more of the steps, the provider computing system 102 may perform one or more other steps, and one or more additional customer devices 120 may perform one or more of the steps. In this regard, the various steps of the method 300 may be performed by various combinations of the devices/elements/hardware described above with reference to FIG. 1.

At step 202, a customer device 120 may initiate, generate, create, or otherwise provide a request to generate a shared account. The customer device 120 may generate the request based on or according to various inputs received via the customer I/O device 124 to the client application 126. The customer device 120 may generate the request to include information/data/inputs provided by a user of the customer device 120 to the client application 126. The inputs may include, for example, information identifying a first account of the user (e.g., an account in the account database 110, such as an account number), information identifying one or more second users in which to share the account (e.g., usernames, email addresses, phone numbers, or other identifiers associated with the second users), etc. The customer device 120 may be configured to transmit, communicate, send, or otherwise provide (e.g., via the network interface 122 over the network 150 to the provider computing system 102) to the request.

At step 204, the provider computing system 102 may receive (e.g., via the network interface 104) the request from the customer device 120. The provider computing system 102 may receive the request responsive to the customer device 120 generating and transmitting the request. At step 206, the provider computing system 102 may create, establish, or otherwise generate the shared account. In some embodiments, the provider computing system 102 may generate the shared account in the shared account database 112. The provider computing system 102 may generate the shared account by creating or establishing a new account number (e.g., associated with the shared account), and creating a link between one or more accounts of the account database 110 and the shared account. For example, the provider computing system 102 may generate a link between the shared account and the first account (e.g., for the user of the first customer device 120) based on or according to the information identifying the first account from the request.

In some embodiments, the provider computing system 102 may generate a distinct type of account number, or other identifier associated with the shared account, to indicate the account is a shared account and distinguish the account from other individual accounts (e.g., using alphanumeric codes such as “SH123AAABBBLLLL”). Generating a unique account number would enable quick processing of transactions into and out of the shared account by the provider computing system 102 to reduce processing power needed to manage the account. Further, the unique account number would insulate the shared account from other accounts to add more security (e.g., walls off shared accounts behind a firewall). In some embodiments, the provider computing system 102 may have separate credentials and/or security protocols needed for this account, as described herein, which makes it non-analogous to traditional demand deposit accounts. Additionally, the provider computing system 102 may generate a new envelope within the account database 110, or the shared account database 112, for the shared account, which transforms the account database 110 or the shared account database 112 in a non-routine manner. In some embodiments, the provider computing system 102 may be configured to generate the unique account number using hash computing using one or more individual account numbers associated with the members of the shared account. In such embodiments, the provider computing system 102 may be configured to reverse look-up each individual account number associated with the shared account based on a predefined hash account number generated for the shared account. At step 206, the provider computing system 102 may determine, detect, or otherwise identify one or more shared customers. The shared customers may be or include users which are identified in the request and which are to be provided access to the shared account. The provider computing system 102 may identify the shared customers based on or according to the information included in the request received at step 204. As stated above, as part of generating the request, a user of the first customer device 120 may include various identifiers associated with shared customers. The provider computing system 102 may identify the shared customers by performing a look-up function using the identifiers from the request in the account database 110. In some embodiments, the provider computing system 102 may generate one or more temporary links between identified accounts (e.g., identified responsive to or based on a returned result from the look-up function) in the account database 110 and the shared account.

At step 208, the provider computing system 102 may generate and communicate, transmit, send, or otherwise provide one or more notifications to customer devices associated with the identified shared customers. In some embodiments, the request received at step 204 may include a token, such as a phone number or email address, associated with the shared customer. The provider computing system 102 may provide the notification to the phone number (or email address) included in the request. In some embodiments, the provider computing system 102 may provide the notification to a different address or device of a user responsive to performing the look-up function (if, for example, the user has a preferred mode of communication stored in association with the user's account in the account database 110 but not included in the request). The notifications may be or include an alert indicating or requesting enrollment of the user in the shared account (e.g., generated at step 206). The notifications may include a user interface for selecting or providing information relating to an account in which to link the shared account. The account of the user may be an account in the account database 110, or an account of a different financial provider (e.g., maintained by a third-party provider).

At step 210, various customer devices 120 (e.g., of shared customers or users) may receive the notification. The customer devices 120 may receive the notification(s) sent by the provider computing system 102 over the network 150 via the network interface 122. The customer devices 120 may receive the notification(s) as a pop-up or alert corresponding to the client application 126. The notification may include a prompt provided as a user interface element or other field for responding to the request to enroll. For example, the notification may include a user interface element (e.g., an enroll button) for selecting to enroll in the shared account, and another user interface element (e.g., a decline button) for declining the invitation to enroll in the shared account. At step 212, the customer device 120 may receive a selection to accept the invitation to enroll in the shared account (e.g., by the user selecting via the I/O device 124 the user interface element to enroll in the shared account). In some embodiments, the notification may include an indication to physically interact with another customer device 120 (e.g., the first customer device 120 associated with the user who initiated the request to generate the shared account). For example, the first user may define security attributes regarding the shared account indicating each secondary joining user must physically interact with the customer device 120 of the first user. In such embodiments, the physical interaction may include “tapping” (e.g., touching) the customer devices 120 together such that one or more sensors of the customer devices 120 can detect the physical interaction. Responsive to detecting the physical interaction, the customer device 120 may receive the acceptance to enroll in the shared account.

At step 214, the customer device 120 may log into the client application 126 or otherwise access/register with the client application 126, to (e.g., at step 216) add or link the shared account with an account of the user. In some embodiments, the user of the customer device 120 may have an account associated with the provider computing system 102 (e.g., an account identified or maintained in the account database 110). In such embodiments, the user of the customer device 120 may log into the client application 126 and select the account identified or included in the client application 126. In some embodiments, the user of the customer device 120 may have an account with a different provider (or may otherwise link the shared account with an account outside of the provider associated with the provider computing system 102). In such embodiments, the user of the customer device 120 may create or establish an account with the client application 126. Once the account is established, the user may provide various inputs for establishing the link between the shared account and the customer's account. For example, the user may provide inputs for establishing the link by providing a routing and account number of the customer's account to a user interface of the client application 126. As another example, the user may provide inputs for establishing the link by selecting a provider associated with the customer's account on, e.g., a drop-down menu, log-into a portal associated with the selected provider, and select the corresponding account in which to establish the link.

At step 218, the provider computing system 102 may acknowledge acceptance of the invitation (e.g., responsive to step 212). For example, when the user selects the user interface element to accept enrollment of the invitation, the customer device 120 may transmit a ping or other packet indicating selection of enrollment. The provider computing device 102 may receive the ping/packet, and acknowledge the packet to the customer device 120. At step 220, when the user logs into or otherwise creates a new account with the client application 126, the provider computing system 102 may be configured to authenticate (e.g., responsive to logging into) or create (e.g., responsive to the user creating) the new account. At step 222, responsive to the user adding/linking the customer's account with the shared account, the information provided by the customer via the client application 126 may be transmitted, communicated, uploaded, or otherwise provided to the provider computing system 102. The provider computing system 102 may receive the information (e.g., identifying the customer's account) via the client application 126 from the customer. The provider computing system 102 may add the account (e.g., identified at step 216) to the shared account by establishing a second link to the account. For example, the provider computing system 102 may establish the link by creating or storing account information of the customer's account in the shared account database 112 in association with the customer identifier for the customer and the shared account generated at step 204. At step 224 and step 226, after registering and generating the links, the provider computing system 102 may provide the user with access to the shared account (e.g., via the client application 126). The user may access the shared account using the client application 126.

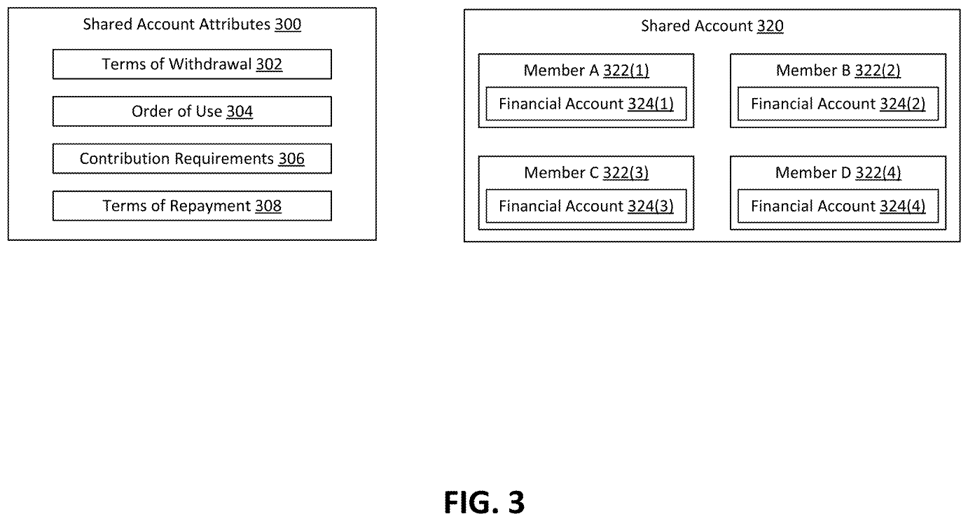

Referring now to FIG. 3, a block diagram of shared account attributes 300 displaying configurable items for a shared account, and a representation of the shared account 320, according to an example implementation of the present disclosure. The shared accounts attributes may be updated/configured as part of generating the request at step 202 described above. In some embodiments, the shared account attributes 300 may be or include account attributes of the shared account, such as whether the shared account is a lending shared account (e.g., an account in which members can selectively obtain a loan with funds from the lending account), a shared savings account (e.g., an account in which members can contribute for savings), etc. In some embodiments, the shared account may include terms of withdraw 302, which may designate a requirement in which the resources associated with the shared account must meet in order for the account to be eligible to withdraw. The order of use 304 may determine or define a method performed by the AI engine 108 (e.g., and/or one or more processor(s) 106) in which a user of the account is chosen to be eligible to withdraw. In some instances, the order of use may be determined at random. In other instances, the order of use may be determined dynamically, for example, by individual account transaction history of each or certain of the linked users to the shared account (e.g., determining which user is in most “need” of a loan using one or more machine learning models as described herein). The contribution requirements 306 may set the requirements for a user to enroll a financial account into the shared financial account. In some instances, the contribution requirements 306 may be or include a regular deposit (e.g., scheduled, routine, or intervaled deposit, such as a weekly/bi-weekly/monthly deposit) into the shared account. In other instances, the contribution requirements 306 may be a large initial deposit into the shared account. The terms of repayment 308 (such as where the account is a loan account) may define or determine a method in which a withdrawal from the shared account into an individual financial account is to be repaid. In some instances, the terms of repayment 308 may be a regular minimum fund transfer at a set time period (e.g., every day, every week, every month, etc.).

The shared account 320 retains a plurality of connected users 322 and their linked financial account 324. Each connected or registered user 322 may register with the shared account 320 as described above with reference to steps 210-214 of FIG. 2. Additionally, the connected users 322 may be configured to connect (e.g., add or link) the shared account with a financial account 324 of the user (e.g., an individual, or non-shared account). The financial account 324 may be an account in the account database 110 (e.g., an account with the provider of the provider computing system 102), or may be a third-party account (e.g., an account with a third-party financial provider or institution). Accordingly, such third-party financial account 324 may require interaction with the third-party computing system 130 in order to transact funds or receive transaction history. The users may link the financial account 324 with the shared account 320 as described above with reference to steps 216 and 222 of FIG. 2. While shown as four users or members linked to the shared account 320, it is noted that any number of users (e.g., greater than or equal to two) can be linked to the shared account 320.

Referring back to FIG. 1, and as described above, the shared account may be or include a shared loan account. The shared loan account may be or include an account in which members contribute to a shared balance. As part of enrollment and at various intervals, shared account members may transfer funds from personal (or individual accounts) to the shared account, to increase the account balance. Similarly, the shared account members may access the shared account at various intervals. The provider computer system 102 may be configured to select, determine, or otherwise identify eligible members to obtain a loan using funds of the shared balance. As described in greater detail below, upon determining an eligible member, the provider computer system 102 may be configured to notify the member of their eligibility to obtain a loan using the funds of the shared account. Once accepted, the provider computing system 102 may initiate a transfer of funds from the shared account to an account of the eligible user.

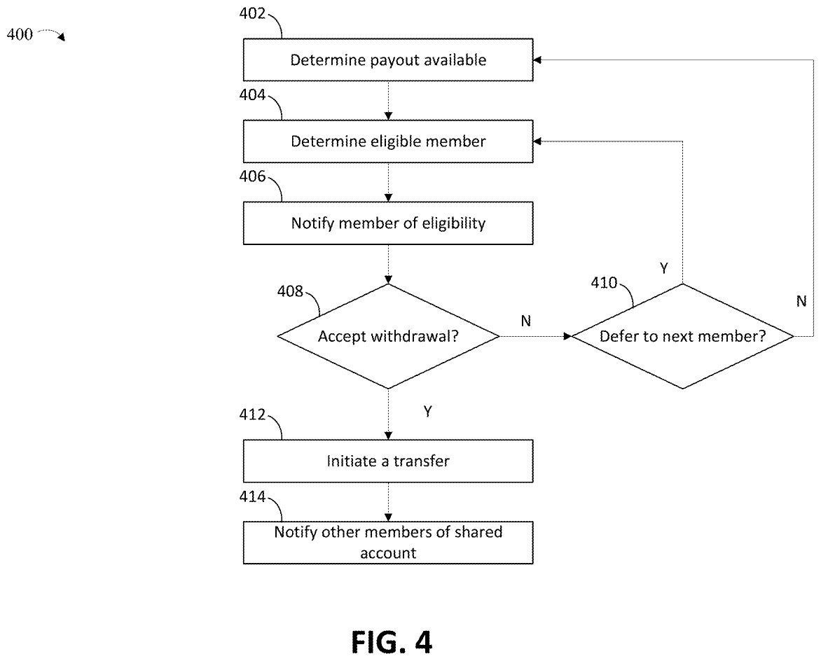

Referring to FIG. 4 in connection with FIG. 1, depicted is a flowchart showing an example method 400 of initiating transfers between a shared account and an individual account, according to an example implementation of the present disclosure. The method 400 may be performed by the devices, components, or elements described above with reference to FIG. 1-FIG. 3. For example, the method 400 may be performed or executed by the provider computer system 102 of FIG. 1.

In some embodiments, the method 400 may be performed responsive to or following execution of the method 200 of FIG. 2. In other words, the method 400 may be performed responsive to a shared (e.g., lending or loan) account being generated. As stated above with reference to FIG. 3, the shared account may include various shared account attributes 300 which may be set, established, or otherwise defined for the shared account. The shared account attributes may include, for example, contribution requirements 306 (e.g., amount and interval, such as a monthly contribution of $1000), an order of use 304 of the shared account (e.g., who has access, alphabetical, random, based on transactions, based on contribution from the member exceeding a threshold, etc.), terms of withdrawal 302 and/or terms of repayment 308 (e.g., interest amount on repayment amount, whether a partial fund withdrawal is permitted, etc.). The members 322 may contribute to the shared account at various intervals.

At step 402, the provider computer system 102 may determine that a payout is available. The provider computer system 102 may determine the payout is available based on or according to receiving an input from a first user device (e.g., of a member) indicating a selection to initiate an inbound transfer (e.g., from the member's individual account) to the shared account. For example, the provider computer system 102 may be configured to receive the input from the user device as part of a regularly scheduled transfer, an on-demand transfer, etc. The provider computer system 102 may be configured to detect that a value associated with the shared account (e.g., an account balance) satisfies a threshold criteria. For example, the provider computer system 102 may be configured to determine that the value satisfies the threshold criteria based on the value (e.g., balance of the shared account) meeting or exceeding a threshold value (e.g., a minimum balance for a loan). The minimum balance may be set or defined according to the account attributes 300. The provider computer system 102 may be configured to determine that the payout is available responsive to the value satisfying the threshold criteria.

At step 404, the provider computer system 102 may detect, select, identify, or otherwise determine an eligible member. In some embodiments, the provider computer system may identify an eligible member from among the plurality of members of the shared account. The provider computer system 102 may identify the eligible member responsive to determining that the payout is available. For example, the provider computer system 102 may identify the eligible member responsive to the value (e.g., associated with the account) satisfying the threshold criteria.

The provider computer system 102 may identify an eligible member based on or according to the order of use 304 of the shared account attributes 300. As stated above, the order of use may set, establish, or otherwise define an order in which members are determined to be eligible for accessing funds (e.g., for a loan) of the shared account. Various examples of orders in which eligible members can be selected are described in greater detail below.

In some embodiments, the order of use 304 may be defined according to an access pattern of members to the shared account. For example, the provider computer system 102 may maintain a ledger of each member accessing the shared account. The provider computer system 102 may record each log-in instance in association with the member identifier for the corresponding member. The provider computer system 102 may be configured to maintain a count of the log-in instances. The AI engine 108 may be configured to flag a member as an eligible member responsive to the count satisfying (e.g., meeting or exceeding) a threshold.

In some embodiments, the order of use 304 may be defined according to contribution amounts from each user. For example, each member may contribute at various instances and amounts to the shared account. The provider computer system 102 may be configured to associate portions of the value of the shared account to each member. The provider computer system 102 may be configured to increase the portion associated with a particular member (e.g., member identifier) as the member contributes more to the shared account. The provider computer system 102 may be configured to flag a member as an eligible member responsive to the portion associated with the member satisfying (e.g., meeting or exceeding) a threshold.

In some embodiments, the order of use 304 may be defined according to one or more particular needs of each member. For example, the provider computer system 102 may be configured to access account balances of each of the members. As part of initial access to the shared account (e.g., at step 226 of FIG. 2) and at various intervals, users of the customer device(s) 120 may provide or indicate a purpose or need for a loan (e.g., for a down payment to a home, a deposit or down payment for a vehicle, to pay off a credit card balance, to perform repairs of a home or automobile, etc.). In some embodiments, the provider computer system 102 (e.g., the AI engine 108) may automatically rank purposes or needs of the users (e.g., using a machine learning model or artificial intelligence, such as RankNet/Ranks SVM, a support vector machine, etc.). For example, the AI engine 108 may use one or more machine learning models to analyze each member's transaction history to determine, based on the transaction history, a ranking of needs of the members (e.g., based on who has had the most expenses, based on who has the lowest balance, etc.). In some embodiments, the users may assign a rank to the purposes or needs of the users. For example, following collecting each of the purposes, the provider computer system 102 may transmit a message or link to each of the customer devices 120. The customer devices 120 may display a user interface for receiving inputs which rank each of the purposes. The provider computer system 102 may be configured to aggregate the received inputs from the customer devices 120, and determine a master rank (e.g., based on, for example, an average ranking) of each of the purposes or needs.

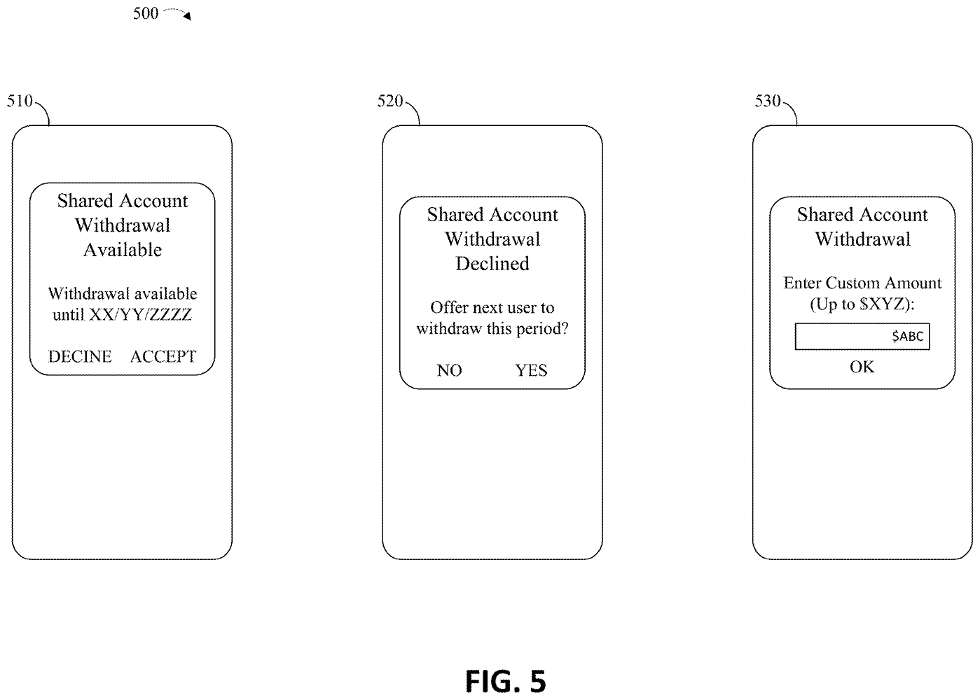

Referring to FIG. 4 and FIG. 5, at step 406, the provider computer system 102 may transmit, send, or otherwise provide a notification to a customer device 120. The provider computer system 102 may provide the notification to the customer device 120 associated with the user identified or determined at step 404. The provider computer system 102 may provide the notification to the customer device 120 by sending a notification to an application executing on the customer device 120 associated with the customer identifier of the eligible member determined at step 404. The notification may indicate availability of an outbound transfer from the shared account to the account of the eligible member. In some embodiments, the notification may be similar to the notification shown on the user interface 510 of FIG. 5. The notification 410 may indicate availability of the outbound transfer (e.g., a shared account withdrawal). In some embodiments, the notification may indicate a timeframe for accepting or declining the outbound transfer. For example, the timeframe may be set from a date of transmitting the notification (e.g., one week from the date), from the date in which the member was identified at step 404, etc.

At step 408, the provider computer system 102 may determine whether the eligible user accepted the withdrawal. For example, the provider computer system 102 may receive a response from the customer device 120 associated with the eligible user, responsive to the eligible user making a selection on the user interface 510 shown in FIG. 5. Where the user accepts the offer, (e.g., by selecting the “accept” user interface element of user interface 510), the method 400 may proceed to step 412. Where the user declines the offer (e.g., by selecting the “decline” user interface element of user interface 510), the method 400 may proceed to step 410.

At step 410, and as shown in user interface 520, where the user declines the offer, the provider computer system 102 may determine whether to defer to another member of the shared account (e.g., to determine the next eligible member). In some embodiments, the eligible user may provide a selection as to whether to defer to another member. For example, the provider computer system 102, responsive to receiving the selection of the “decline” user interface element of the user interface 510, may display the user interface 520. The user may select whether or not to offer the eligible withdrawal to the next eligible user within a time period (e.g., within the timeframe, within a larger time window (such as a month), etc.). For example, the user may select not to offer to the next user where the user intends to select to accept the offer within the timeframe (e.g., but not on the date in which the notification was sent). Where the user selects the “no” user interface element of user interface 520, the method 400 may return to step 402. On the other hand, where the user selects the “yes” user interface element of user interface 520, the method 400 may return to step 404, where the provider computer system 102 selects or determines the next eligible member.

Returning to step 408, where the provider computer system 102 determines that the user selects to accept the offer, the method 400 may proceed to step 412. The provider computer system 102 may determine that the user selects to accept the offer responsive to receiving a selection of the “accept” user interface element of user interface 510. At step 412, the provider computer system 102 may initiate a transfer. In some embodiments, the provider computer system 102 may initiate a transfer in an amount specified by the eligible member. For example, as shown in FIG. 5, when the user selects the accept user interface element of user interface 510, the customer device 120 may display user interface 530 including a field for selecting an amount. The eligible user may select, input, or otherwise provide an amount in which to transfer from the shared account. The provider computer system 102 may be configured to receive the value specified in the field by the user (e.g., responsive to the user inputting the value to the field and selecting the “OK” user interface element). The provider computer system 102 may initiate a transfer in the amount specified (e.g., in the response to the notification displayed at step 406). The provider computer system 102 may initiate the transfer from the shared account to the account (e.g., personal account or individual account) of the eligible member.

At step 414, the provider computer system 102 may transmit, communicate, send, or otherwise provide a notification to other members of the shared account. In some embodiments, the provider computer system 102 may provide the notification to each of the devices associated with non-eligible members. The notification may indicate, identify, or otherwise notify the members that a loan/withdrawal as occurred. The notification may indicate the amount of the loan, repayment terms, balance of the shared account after the withdrawal, balance of the shared account after repayment (e.g., including interest), a name of the individual who withdrew the loan, etc. In some embodiments, the shared account attributes 300 (e.g., defined by a user) may include a setting to define various privacy implementations (e.g., restrictive sharing) regarding the shared account. For example, the attributes 300 may include an indication to only share deposit and withdrawal amounts in the notification to the members of the shared account, while hiding other specifics of the transactions (e.g., merchant names, locations, etc.). In such embodiments, the provider computing system 102 may be configured to analyze less data regarding the transactions to determine the order of use 304 and members' privacy is prioritized relative to the shared accounts. The outbound transfer, as described above, may be a loan using the funds of the shared account. In this regard, and at various intervals, the provider computer system 102 may receive inbound transfers from the eligible users. The provider computer system 102 may receive inbound transfers at various intervals in an amount to repay the loan (e.g., including interest). The provider computer system 102 may receive inbound transfers until the balance of the loan is paid off.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by a computing system, a request from a first user device associated with a first member to form a shared account with one or more second members, the request including information identifying a first account of the first member;
generating, by the computing system, the shared account including a first link between the shared account and the first account, wherein the generated shared account includes a unique account number indicating the shared account is accessible by multiple members;
transmitting, by the computing system, one or more messages to one or more second user devices associated with the one or more second members;
generating, by the computing system, one or more second links between one or more second accounts of the one or more second members and the shared account, the one or more second links generated according to a response to the one or more messages received from the one or more second user devices;
establishing, by the computing system, a value associated with the shared account, the value having a first portion associated with the first account and one or more second portions associated with each of the one more second accounts;
receiving, by the computing system, an input via the first user device indicating a selection to initiate an inbound transfer of a first amount from the first account to the shared account to increase the value associated with the shared account;
detecting, by the computing system, that the value associated with the shared account satisfies a threshold criteria;
identifying, by the computing system, an eligible member from among the first member and the second member responsive to the value satisfying the threshold criteria and according to at least one machine learning model that considers financial transaction information of each linked second member;
transmitting, by the computing system, a notification to the user device of the eligible member, the notification indicating availability of an outbound transfer from the shared account to the account of the eligible member;
receiving, by the computing system, a response from the user device, the response selecting to initiate the outbound transfer from the shared account to the account of the eligible member; and
initiating, by the computing system, the outbound transfer in an amount specified in the response from the shared account to the account of the eligible member.

2. The method of claim 1, further comprising initiating, by the computing system, a second inbound transfer from the account of the eligible member in the amount to the shared account.

3. The method of claim 2, wherein the outbound transfer comprises a loan against the shared account, and wherein the second inbound transfer comprises a repayment of the loan.

4. The method of claim 1, further comprising determining, by the computing system, an access pattern of first user and the one or more second members, wherein the eligible member is identified according to the access pattern.

5. The method of claim 4, wherein the access pattern is determined by an analysis of at least one transaction within an account of the first member and an account of the second member.

6. The method of claim 1, wherein inbound transfer comprises a recurring inbound transfer from the first account to the shared account.

7. The method of claim 1, wherein the notification comprises a withdrawal allowance notification, and a user interface element allowing for the eligible member to defer the withdrawal to another user within the shared financial account.

8. The method of claim 1, wherein the notification comprises a withdrawal allowance notification, and a user interface element for receiving a selection of the amount to transfer via the outbound transfer.

9. The method of claim 1, wherein the first member is the eligible member responsive to the first portion associated with the first account exceeding a threshold value.

10. A computing system, comprising:
a network interface;
a first database structured to store a plurality of accounts of a provider;
a second database structured to store a plurality of shared accounts containing group member information; and
a processing circuit comprising one or more processors and a memory, the processing circuit configured to:
receive, via the network interface, a request from a first user device associated with a first member to form a shared account with one or more second members, the request including information for identifying a first account of the first member;
generate, in the second database, the shared account including a first link between the shared account of the second database and the first account of the first database, wherein the generated shared account includes a unique account number indicating the shared account is accessible by multiple members;
transmit, via the network interface, one or more messages to one or more second user devices associated with the one or more second members;
generate one or more second links between one or more second accounts of the one or more second members of the first database and the shared account of the second database, the one or more second links generated according to a response to the one or more messages received from the one or more second user devices;
establish a value associated with the shared account, the value having a first portion associated with the first account and one or more second portions associated with the second account;
receive, via the network interface, an input via the first user device indicating a selection to initiate an inbound transfer of a first amount from the first account to the shared account, to increase the value associated with the shared account;
detect that the value associated with the shared account satisfies a threshold criteria;
identify an eligible member from among the first member and the second member responsive to the value satisfying the threshold criteria and according to at least one machine learning model that considers financial transaction information of each linked second member;
transmit, via the network interface, a notification to the user device of the eligible member, the notification indicating availability of an outbound transfer from the shared account to the account of the eligible member;
receive, via the network interface, a response from the user device, the response selecting to initiate the outbound transfer from the shared account to the account of the eligible member; and
initiate the outbound transfer in an amount specified in the response from the shared account to the account of the eligible member.

11. The computing system of claim 10, wherein the processing circuit is further configured to initiate a second inbound transfer from the account of the eligible member in the amount to the shared account.

12. The computing system of claim 11, wherein the outbound transfer comprises a loan against the shared account, and wherein the second inbound transfer comprises a repayment of the loan.

13. The computing system of claim 11, wherein the processing circuit is further configured to determine an access pattern of first user and the one or more second members, wherein the eligible member is identified according to the access pattern.

14. The computing system of claim 13, wherein the access pattern is determined by analysis of transactions within an account of the first member and an account of the second member.

15. The computing system of claim 10, wherein inbound transfer comprises a recurring inbound transfer from the first account to the shared account.

16. The computing system of claim 10, wherein the notification comprises a withdrawal allowance notification, and a user interface element allowing for the eligible member to defer the withdrawal to another user within the shared financial account.

17. The computing system of claim 10, wherein the notification comprises a withdrawal allowance notification, and a user interface element for receiving a selection of the amount to transfer via the outbound transfer.

18. The computing system of claim 10, wherein the first member is the eligible member responsive to the first portion associated with the first account exceeding a threshold value.

19. A non-transitory computer readable medium storing instructions that, when executed by one or more processors of a processing system, cause the processing system to perform operations comprising:
receiving, via a network interface, a request from a first user device associated with a first member, the request to form a shared account with one or more second members, the request including information for identifying a first account of the first member;
generating, in a first database, the shared account including a first link between the shared account of the first database and the first account of a second database, wherein the generated shared account includes a unique account number indicating the shared account is accessible by multiple members;
transmitting, via the network interface, one or more messages to one or more second user devices associated with the one or more second members;
generating one or more second links between one or more second accounts of the one or more second members of the first database and the shared account of the second database, the one or more second links generated according to a response to the one or more messages received from the one or more second user devices;
establishing a value associated with the shared account, the value having a first portion associated with the first account and one or more second portions associated with the second account;
receiving, via the network interface, an input via the first user device indicating a selection to initiate an inbound transfer of a first amount from the first account to the shared account, to increase the value associated with the shared account;
detecting that the value associated with the shared account satisfies a threshold criteria;
identifying an eligible member from among the first member and the second member responsive to the value satisfying the threshold criteria and according to at least one machine learning model that considers financial transaction information of each linked second member;
transmitting, via the network interface, a notification to the user device of the eligible member, the notification indicating availability of an outbound transfer from the shared account to the account of the eligible member;
receiving, via the network interface, a response from the user device, the response selecting to initiate the outbound transfer from the shared account to the account of the eligible member; and
initiating the outbound transfer in an amount specified in the response from the shared account to the account of the eligible member.

20. The non-transitory computer readable medium of claim 19, wherein the instructions further cause the processing system to perform operations comprising initiating a second inbound transfer from the account of the eligible member in the amount to the shared account, wherein the outbound transfer comprises a loan against the shared account, and wherein the second inbound transfer comprises a repayment of the loan.
